(19) United States
(12) Patent Application Publication
(10) Pub. No.: US 2017/0144886 A1
(43) Pub. Date: May 25, 2017

(54) A CATALYST FOR DIRECT SYNTHESIS OF HYDROGEN PEROXIDE, ITS PREPARATION AND USE

(71) Applicant: SOLVAY SA, Brussels (BE)

(72) Inventors: Frédérique DESMEDT, Brussels (BE); Pierre MIQUEL, Roubaix (FR); Yves VLASSELAER, Leefdaal (BE)

(21) Appl. No.: 15/319,899

(22) PCT Filed: Jun. 23, 2015
(86) PCT No.: PCT/EP2015/064020

§ 371 Date: Dec. 19, 2016

(30) Foreign Application Priority Data
Jun. 25, 2014 (EP) 14173963.1

(51) Int. Cl. C01B 15/029; B01J 37/02; B01J 23/46; B01J 21/06; B01J 27/053

(52) U.S. Cl. CPC C01B 15/029; B01J 21/066; B01J 27/053; B01J 23/464; B01J 37/0201

(57) ABSTRACT

A catalyst comprising a platinum group metal (group 10) supported on a carrier, said carrier comprising a silica core and a precipitate layer of comprising a metal oxide, sulfate or phosphate on said core; said catalyst also comprising a rhodium group metal (group 9) supported on said carrier.

This application claims priority to European application No EP 14173963.1 filed on 25 Jun. 2014, the whole content of this application being incorporated herein by reference for all purposes.

### TECHNICAL FIELD

This invention relates to a catalyst for the direct synthesis of hydrogen peroxide, to a process for manufacturing said catalyst and to a process for producing hydrogen peroxide, comprising reacting hydrogen and oxygen in the presence of the catalyst according to the invention.

### STATE OF THE ART

Hydrogen peroxide is a highly important commercial product widely used as a bleaching agent in the textile or paper manufacturing industry, a disinfecting agent and basic product in the chemical industry and in the peroxide compound production reactions (sodium perborate, sodium percarbonate, metallic peroxides or percarboxyl acids), oxidation (amine oxide manufacture), epoxidation and hydroxylation (plasticizing and stabilizing agent manufacture).

Commercially, the most common method to produce hydrogen peroxide is the “anthraquinone” process. In this process, hydrogen and oxygen react to form hydrogen peroxide by the alternate oxidation and reduction of alkylated anthraquinones in organic solvents. A significant disadvantage of this process is that it is costly and produces a significant amount of by-products that must be removed from the process.

One highly attractive alternative to the anthraquinone process is the production of hydrogen peroxide directly by reacting hydrogen and oxygen in the presence of metal catalysts supported on various oxides such as silica as a catalyst carrier.

However, in these processes, when a catalyst based on silica as carrier is used for the direct synthesis of hydrogen peroxide, the reaction product, i.e., hydrogen peroxide was not efficiently produced since the production of water as a by-product is very high and even higher than the hydrogen peroxide production after a certain period of time.

To prevent these drawbacks, alternative processes based on other carriers where developed, but they generally suffer from a very poor mechanical behavior of this catalyst since it is fragile and shows a significant attrition. Examples of such carriers are metal oxides like Zr, Nb and Ta oxides; and sulfates and phosphates of alkaline-earth metals like BaSO4.

Therefore, mixed catalysts were developed wherein metal oxides, sulfates and phosphates were supported (precipitated) on silica to form a carrier for an active metal generally comprising palladium: see for instance WO 2013/068243 (Zr oxide on silica), WO 2013/068340 (Nb and Ta oxides on silica) and WO 2014/072169 (sulfates and phosphates of alkaline-earth metals on silica) all in the name of the Applicant.

Although all these catalysts have a high selectivity and a good mechanical resistance, it has been found however that their selectivity decreases over time probably because the active metal is at the same time leaching out and making aggregates at the surface of the catalyst.

Co-pending application EP 14152454.6 in the name of the Applicant proposes a catalyst for the direct synthesis of hydrogen peroxide, which has a selectivity which is more stable over time. This object could be reached thanks to the fact of putting on the surface of the carrier, besides the metal oxide, sulfate or phosphate precipitate, an oxide from another metal chosen from W, Mo, Ta and Nb and which is different from the metal in the precipitate, and which is preferably W. These catalysts give indeed better results but could however still be improved.

On the other hand, H2O2 direct synthesis (DS) catalysts containing both Pd and Rh were disclosed in U.S. Pat. No. 5,505,921, an old patent in the name of the Applicant as well. In this document, the Pd and Rh precursors are reduced in the aqueous solution by addition of Na formate. The productivity of these catalysts shown in examples 65 to 77 is very low (5.7 g H2O2/(g Pd×h) max.) and there is also no evidence that, in their case, they improve the catalyst selectivity.

We have now found that surprisingly, when adding both Pd and Rh on the above mentioned modified silica carrier, and preferably by the incipient wetness method, it is possible to increase at least the selectivity of the reaction. In some cases, it is even possible to increase the H2O2 productivity too.

An advantage of the invention is that there is no need to introduce an equivalent amount of Pd and Rh. A good Pd/Rh weight ratio is namely about 1.0/0.1. It is an advantage in comparison with other inventions where it is required to add an equivalent amount of the two noble metals (catalysts based on Pd/Au). So the catalyst of the present invention is cheaper to produce.

Another advantage of the invention is the ease of the catalyst preparation. Indeed, as will be explained in detail further on, the noble metals can (and are preferably) introduced in the carrier by impregnation (incipient wetness) which is one of the most common and easy methods and which seems nevertheless to succeed in obtaining the good configuration of the nanoparticles on the catalyst surface and, by doing so, to enhance the selectivity of the reaction.

In the cases where it is only possible to improve the selectivity and not the hydrogen peroxide production, the present invention still provides an advantage because the main issue for an industrial process is to obtain a high selectivity and not so much to obtain a high conversion rate of the hydrogen (which is the limiting reactant). Indeed, at industrial scale, it is possible to recycle the gas and complete it with the hydrogen missing. On the other hand, a lack of selectivity means formation of water which cannot be valorized and induces undue costs.

Therefore, the present invention relates to a catalyst comprising a platinum group metal (group 10) supported on a carrier, said carrier comprising a silica core and a precipitate layer of comprising a metal oxide, sulfate or phosphate on said core; said catalyst also comprising a rhodium group metal (group 9) supported on said carrier. In a preferred embodiment, the present invention relates to a catalyst comprising Pd supported on a carrier, said carrier comprising a silica core and a precipitate layer comprising a metal oxide, sulfate or phosphate on said core; said catalyst also comprising Rh supported on said carrier in an amount of from 1% to 50% of the amount of Pd.

The present invention also relates to a method for manufacturing such a catalyst according to which the metals of group 10 and 9 are deposited (supported) onto the carrier by impregnation of precursors thereof i.e. by using the so called “incipient wetness” method. In a preferred embodiment of this method, Pd and Rh are supported onto the carrier by impregnation of precursors thereof.

The present invention also relates to the use of such catalysts in direct synthesis of hydrogen peroxide in a reaction medium comprising hydrogen and oxygen.

### DETAILED DESCRIPTION OF THE INVENTION

The expression “carrier” intends herein to denote the material, usually a solid with a high surface area, to which the catalytic metal is affixed.

According to the invention, this carrier comprises a silica core and a precipitate layer thereon. In such a structure, the catalytic metal is in fact deposited on the precipitate layer and the silica only acts as mechanical support for the latter. The silica can essentially be amorphous like a silica gel or can be comprised of an orderly structure of mesopores, such as, for example, of types including MCM-41, MCM-48 and SBA-15. Good results were obtained with silica gel.

Generally, said support has a BET surface of at least 100 m2/g, preferably of at least 200 m2/g. Generally, said support has a pore diameter of more than 5 nm but less than 50 nm, preferably in the range of 10 nm. It also generally has a total pore volume of more than 0.1 ml/g but less than 5 ml/g, preferably in the range of 1 ml/g.

In specific embodiments of the present invention, the amount of silica is from 30 to 99 wt. %, more preferably from 50 to 98 wt. % and most preferably from 70 to 97 wt. %, based on the total weight of the carrier.

Generally, the silica core comprises particles having a mean diameter in the range of 50 μm to 5 mm, preferably from 100 μm to 4 mm and even more preferably, from 150 μm to 3 mm. In practice, good results are obtained with a mean particle size in the range of the hundreds of μm. This particle size is based on laser diffraction measurements on the particles in suspension in a liquid, more specifically using a laser Coulter LS230 apparatus based on a wave length of 750 nm for the incident light. The size distribution is calculated in % in volume.

According to the invention, the silica core has a precipitate comprising (and preferably being substantially made of) a metal oxide, sulfate or phosphate on it. The metal oxide is preferably chosen from Zr, Nb and Ta oxides (like in the above mentioned applications WO 2013/068243 and WO 2013/068340, the content of which is incorporated by reference in the present application). The metal sulfate or phosphate preferably is an alkaline-earth metal sulfate of phosphate or a sulfate or phosphate from a metal chosen from Zr, Nb and Ta, more preferably BaSO4 (like in the above mentioned application WO 2014/072169, the content of which being also incorporated by reference in the present application) or Nb phosphate.

A precipitate layer comprising ZrO2 or BaSO4 gives good results in the present invention. A precipitate layer comprising BaSO4 is preferred because it allows keeping both conversion and selectivity high.

The precipitation of ZrO2 on the silica core may be accomplished by a variety of techniques known in the art. One such method involves impregnating the silica with a precursor of zirconium oxide e.g., ZrOCl₂, optionally followed by drying. The zirconium oxide precursor may include any suitable zirconium hydroxide, zirconium alkoxide, or zirconium oxyhalide (such as ZrOCl₂).

In a preferred embodiment, the precursor of zirconium oxide is an oxyhalide of zirconium, preferably zirconium oxychloride. The precursor is converted, for example after hydrolysis followed by heat treatment, to zirconium oxide, which is precipitated onto the silica core to produce the carrier.

The precipitation of BaSO4 on the silica core may also be accomplished by a variety of techniques known in the art. Preferably, barium sulfate is generated by combining solutions of barium ions and sulfate ions (salts or acids). In practice, mixing a barium salt solution with sulfuric acid gives good results. Preferably, the barium salt is a halide. Barium chloride gives good results and is easily available commercially.

The precipitate of the invention can be a continuous or discontinuous layer on the silica core. Generally, part of the silica particles of which the core is made, are covered by the precipitate. Said precipitate generally also comprises particles, generally of substantially spherical shape, generally having a mean particle size in the range of 10 nm.

The catalyst of the invention comprises a metal from group 10 (platinum group), preferably Pt or Pd, more preferably Pd supported on the above described carrier.

The amount of metal of group 10 (preferably Pd) supported on the carrier can vary in a broad range, but is preferably from 0.001 to 10 wt. %, more preferably from 0.1 to 5 wt. % and most preferably from 0.5 to 3 wt. %, each based on the weight of the carrier.

The catalyst of the invention also comprises a metal from group 9 (rhodium group), preferably Rh or Ir, more preferably Rh supported on the above described carrier.

The amount of metal of group 9 (preferably Rh) supported to the carrier can vary in a broad range, but is preferably from 1% to 50% of the amount of the metal of group 10, more preferably from 2 to 30% and even more preferably, from 5 to 20% of the amount of the metal of group 10.

The catalyst according to the invention has a large specific surface area determined by the BET method, generally greater than 20 m²/g, preferably greater than 100 m²/g.

Preferably, the catalyst according to the invention comprises only one metal of group 9 (preferably Rh) and only one metal of group 10 (preferably Pd) and no other active metal supported on its carrier (except of course in a typical impurity range (i.e. not catalytically active), like in the range of the ppm for instance). This embodiment is effective, economic and easy to obtain in practice.

The addition of the metals of group 10 and 9 (preferably Pd and Rh) to the carrier can be performed using any of the known preparation techniques of supported metal catalyst, e.g. impregnation, adsorption, ionic exchange, etc. For the impregnation (incipient wetness), which is the preferred method according to the invention, it is possible to use any kind of precursors, generally inorganic or organic salts of the metals to be impregnated that are soluble in the solvent(s) used in addition to the metals. Suitable salts are for example halides such as chlorides or chloride hydrates, acetates, nitrates, oxalates, etc. Halides such as chlorides or chloride hydrates are preferred.

Hence, in a second aspect, the present invention relates to a method for manufacturing a catalyst as described above according to which the metals of group 10 and 9 (preferably Pd and Rh) are deposited onto the carrier by impregnation of precursors thereof i.e. by using the so called “incipient wetness” method.

The metals may be impregnated by various ways known in the art. For example, the metals can be deposited by dipping (or mixing) the carrier to a solution of halides (or hydrates thereof) of the metals followed by reduction. In more specific embodiments, the reduction is carried out in the presence of a reducing agent, preferably gaseous hydrogen at a temperature between room temperature and 500° C., preferably between 50 and 400° C. and more preferably between 100 and 350° C.

In this aspect of the invention, preferably, only one metal of group 9 (preferably Rh) and only one metal of group 10 (preferably Pd) are supported onto the carrier and no other active metal is deposited thereon. Again, this embodiment is effective, economic and easy to obtain in practice.

In a third aspect of this invention, the invention is also directed to the use of the catalyst according to the invention in production of hydrogen peroxide by direct synthesis in a reaction medium comprising hydrogen and oxygen.

In the process of the invention, hydrogen and oxygen (as purified oxygen or air) are reacted continuously over a catalyst in the presence of a liquid solvent in a reactor to generate a liquid solution of hydrogen peroxide. The catalyst is then used for the direct synthesis of hydrogen peroxide in a three phase's system: the catalyst (solid) is put in a solvent (alcohol or water) and the gases (H₂, O₂ and an inert gas) are bubbled in the suspension in presence of stabilizing additives (halides and/or inorganic acid). In these processes, H⁺ and Br⁻ ions are generally required in the reaction medium in order to obtain high concentrations of hydrogen peroxide. These ions are obtained from strong acids, such as sulfuric, phosphoric, hydrochloric or nitric acids and organic or inorganic bromides.

The process of this invention can be carried out in continuous, semi-continuous or discontinuous mode, by the conventional methods, for example, in a stirred tank reactor with the catalyst particles in suspension, in fixed bed reactor, in a basket-type stirred tank reactor, etc. Once the reaction has reached the desired conversion levels, the catalyst can be separated by different known processes, such as, for example, by filtration if the catalyst in suspension is used, which would afford the possibility of its subsequent reuse. In this case the amount of catalyst used is that necessary to obtain a concentration 0.01 to 10 wt. % regarding the solvent and preferably being 0.1 to 5 wt. %. The concentration of the obtained hydrogen peroxide according to the invention is generally higher than 5 wt. %, preferably higher than 7 wt. %.

Throughout the description and the claims, the word “comprises” and the variations thereon do not intend to exclude other technical features, additives, components or steps. For the experts in this field, other objects, advantages and characteristics of the invention will be inferred in part from the description and in part from the embodiment of the invention.

The following examples are provided for illustrative purposes and are not intended to be limiting the scope of the present invention.

1. Preparation of the Catalyst

An aqueous solution of palladium chloride and the other metal(s) precursor(s) was/were prepared with the amount of Pd and/or Pt and/or gold and/or rhodium necessary in order to obtain the desired loading of the several metals on the catalyst. Typically the total volume of the solution for 20 g of carrier was 24 ml. Some drops of HCl (from 4 to 20) were added to the suspension and the medium was heated at 70° C. under magnetic stirring until all the precursor salts have been dissolved.

The solution was added to the carrier and well mixed until all the liquid phase was adsorbed by the carrier (incipient wetness). The catalyst was dried at 95° C. for 24 hours. The Pd was reduced under influence of hydrogen, diluted with nitrogen, during 5 hours at 150° C.

Carriers Used:

In all cases, the starting material (core) was silica from the company Yongji having a surface area of 400 m2/g, a pore volume of 1.2 ml/g and a pore diameter of 10 nm.

BaSO4 Deposition on Silica:

In a flask of 250 cc, 40.44 g of silica were introduced and put on a rotating dryer. They were heated at 75° C. and the pump was started for obtaining a vacuum of 230 mbars.

An aqueous solution of 2.78 g barium chloride (BaCl₂) in 65 ml of demineralized water was prepared at room temperature.

This solution was introduced drop by drop in the rotating dryer, under vacuum. The water was evaporated directly and the barium salt was precipitated on the silica.

250 cc of sulfuric acid 0.12M were introduced slowly, drop by drop directly in the flask at 75° C. and 110 mbars. The water and the HCl were evaporated directly and barium sulfate was formed on the surface.

The support was washed with demineralized water, dried during one night at 95° C., grinded and calcined during 5 h at 600° C.

Zr Oxide Deposition on Silica:

In a beaker of 1 L, 2 drops of NH4OH 25% Wt were added to reach a pH around 8.5. 50.01 g of silica were introduced and mechanically stirred (around 260 rpm). The suspension was heated at 50° C.

14.73 g of ZrOCl₂ were dissolved at room temperature in 26.75 g of demineralized water. When the temperature was stable, pH was rectified.

The solution of ZrOCl₂ was introduced slowly with a syringe pump (all the solution in +/−30 minutes). At the same time, the pH was maintained between 8.4 and 8.5 by adding some drops of NH₄OH 25% Wt.

The suspension was then left under stirring at 50° C. during one hour and then, at room temperature during 20 minutes without stirring.

The suspension was filtered and the solid recovered washed with 500 cc demineralized water.

The solid was dried during 24 hours at 95° C., then calcined at 600° C. during 3 hours.

Metal precursors used:

Palladium (II) chloride

Chloroplatinic acid solution—8 wt. % in H₂O

Gold (III) chloride solution—+/−30% Wt in dilute HCl

Rhodium (III) chloride hydrate

2. Direct Synthesis of Hydrogen Peroxide

In a HC276 250cc reactor, methanol (150 g), hydrogen bromide (from 18 to 65 ppm, depending of the catalyst type); ortho-phosphoric acid (0.1M-H₃PO₄) and catalyst (0.5 g. for the catalyst based on Zr oxide on silica to 1.2 g. for the catalysts based on BaSO4 on silica depending of the catalyst type) were introduced in a slurry reactor equipped with a mechanical stirrer, a thermocouple, a gas inlet and a dipping pipe equipped with a filter to take liquid samples. The amount of o-phosphoric acid was calculated to obtain a final concentration of 0.1M.

The reactor was cooled to 5° C. and the working pressure was set at 50 bar (obtained by introduction of nitrogen).

The reactor was flushed during the entire reaction time with the following mixture of gases: Hydrogen (3.6% Mol)/Oxygen (55.0% Mol)/Nitrogen (41.4% Mol). The total flow was 2708 mlN/min

When the composition of the gas phase coming out was stable (checked by GC (Gas Chromatography) on line). This technique is used to separate the components of a gas mixture and measure their relative quantities. The sample is rapidly heated and vaporized at the injection point. The sample is transported through the column by a mobile phase consisting of an inert gas (argon as it increases the detector H2 sensitivity towards H2 at the detector). Sample components are separated based on their sizes (size exclusion chromatography). The stationary phase consists of a molecular sieve (MSSA), and the larger the particle is the slower it comes off the column. The components are then detected and represented as peaks on a chromatogram. The integration of the different pics gives us information on their relative quantities. The detector used here is a TCD (Thermal Conductivity Detector).

The mechanical stirrer was started at 1200 rpm.

GC on line analyzed every 15 minutes, the composition of gas phase coming out of the reactor.

Liquid samples were taken to measure hydrogen peroxide and water concentration.

Hydrogen peroxide was measured by redox titration with cerium sulfate.

Water was measure by Karl-Fisher.

3. Results and Comments

The results obtained can be found in Tables 1 to 11 below.

Tables 1 to 5 relate to catalysts having a carrier based on a Si02 core provided with a Zr02 precipitate layer while Tables 6 to 11 relate to catalysts having a carrier based on a Si02 core provided with a BaSO4 precipitate layer.

The units used to express these results are the following:

Selectivity, %=H₂O₂ conc./(H₂O₂ conc. +H₂O conc.)

Conversion, %=H₂ consumed/H₂ fed

Productivity=H₂O₂ produced (g)/(duration of the test (h)×(Pd used in the reactor (g)).

The following conclusions can be drawn from these tables:

Pd/Au Based Catalysts (Examples 7, 14-16, 28 and 36-38, Not According to the Invention):

In order for these catalysts to perform well, it is required to be close to an equivalent Pd/Au weight (for example a 1/1 ratio), which is costly. Indeed, when the Au loading is decreased, the global performances of the catalysts decrease and become equivalent to those obtained for pure Pd based catalysts (Examples 4 and 24, not according to the invention).

Pd/Pt Based Catalysts (Examples 6, 11-13, 27 and 33-35, Not According to the Invention):

Good results are also obtained for a low Pt loading. However, these good results are obtained thanks to an increase of the conversion rate mainly. No improvement of the selectivity is observed for such type of catalyst. Even more, the selectivity observed is lower than the one obtained for pure Pd based catalyst (Examples 4 and 24, not according to the invention). When the Pt load increases, performances are worse.

Pd/Rh Based Catalysts (Examples 1-3, 5, 21-23, 25-26 and 44-45, According to the Invention):

The catalysts with a weight ratio Pd/Rh close to the equivalence show dramatically bad performances. The selectivity is very low. However, when the catalyst includes only a very small amount of Rh (Pd/Rh weight ratio=1/0.1), the selectivity is clearly enhanced. In some cases (Zr oxide/silica) the conversion is a little bit lower but this is not an issue as explained above. In the case of BaSO4 on silica, the conversion remains constant and so both selectivity and H2O2 productivity are improved.

TABLE 1
Influence of small amount of Rh on selectivity

| | Pd | Rh | | H2O2 | H2O | Selectivity, % | | | Productivity |
|---|---|---|---|---|---|---|---|---|---|
| Ex. N° | % Wt | % Wt | | g/kg | g/kg | Init | Fin | Conversion, % | g H2O2/(g Pd × h) |
| 1 | 1.6 | 0.83 | Pd/Rh | 48.5 | 34.9 | 69 | 44 | 36 | 206 |
| 2 | 1.4 | 0.95 | Pd/Rh | 43.1 | 30.4 | 69 | 44 | 31 | 210 |
| 3 | 1.55 | 0.99 | Pd/Rh | 41.5 | 35.3 | 63 | 40 | 40 | 181 |
| 4 | 1.3 | | Pd | 69.3 | 26.1 | 75 | 61 | 38 | 364 |
| 5 | 1.3 | 0.12 | Pd/Rh | 59 | 16.7 | 80 | 69 | 27 | 311 |

TABLE 2
Influence of small amount Rh in comparison to small amount of Pt or Au

| | Pd | Pt | Au | Rh | | H2O2 | H2O | Selectivity, % | | | Productivity |
|---|---|---|---|---|---|---|---|---|---|---|---|
| Ex. N° | % Wt | % Wt | % Wt | % Wt | | g/kg | g/kg | Init | Fin | Conversion, % | g H2O2/(g Pd × h) |
| 4 | 1.3 | | | | Pd | 69.3 | 26.1 | 75 | 61 | 38 | 364 |
| 6 | 1.6 | 0.17 | | | Pd/Pt | 90.6 | 31.1 | 66 | 63 | 53 | 385 |
| 5 | 1.3 | | | 0.12 | Pd/Rh | 59 | 16.7 | 80 | 69 | 27 | 311 |
| 7 | 1.2 | | 0.15 | | Pd/Au | 69.7 | 25.9 | 76 | 61 | 37 | 396 |

TABLE 3
Trimetals based catalysts compared to small amount of Rh only

| | Pd | Pt | Au | Rh | | H2O2 | H2O | Selectivity, % | | | Productivity |
|---|---|---|---|---|---|---|---|---|---|---|---|
| Ex. N° | % Wt | % Wt | % Wt | % Wt | | g/kg | g/kg | Init | Fin | Conversion, % | g H2O2/(g Pd × h) |
| 8 | 1.65 | 0.16 | | 0.01 | Pd/Pt/Rh | 69.7 | 29.8 | 70 | 57 | 44 | 290 |
| 4 | 1.3 | | | | Pd | 69.3 | 26.1 | 75 | 61 | 38 | 364 |
| 9 | 1.6 | 0.17 | 0.17 | | Pd/Pt/Au | 92 | 32.9 | 66 | 61 | 56 | 389 |
| 5 | 1.3 | | | 0.12 | Pd/Rh | 59 | 16.7 | 80 | 69 | 27 | 311 |
| 10 | 1.2 | | 0.14 | 0.09 | Pd/Au/Rh | 68.5 | 19.1 | 78 | 68 | 31 | 384 |

TABLE 4
Influence of small amount Rh in comparison to big amount of Pt or Au

| | Pd | Pt | Au | Rh | | H2O2 | H2O | Selectivity, % | | | Productivity |
|---|---|---|---|---|---|---|---|---|---|---|---|
| Ex. N° | % Wt | % Wt | % Wt | % Wt | | g/kg | g/kg | Init | Fin | Conversion, % | g H2O2/(g Pd × h) |
| 11 | | 1.1 | | | Pd/Pt | 69 | 41.5 | 63 | 48 | 62 | 311 |
| 12 | | 1.6 | | | Pd/Pt | 54 | 51.4 | 57 | 37 | 59 | 227 |
| 13 | | 1.2 | | | Pd/Pt | 56 | 54.7 | 57 | 36 | 54 | 323 |
| 14 | 1.4 | | 1.1 | | Pd/Au | 94 | 27.6 | 80 | 66 | 52 | 457 |
| 15 | 1.65 | | 1.2 | | Pd/Au | 97 | 30.3 | 78 | 64 | 57 | 399 |
| 16 | 1.8 | | 1.5 | | Pd/Au | 96 | 32.9 | 74 | 63 | 60 | 364 |
| 4 | 1.3 | | | | Pd | 69.3 | 26.1 | 75 | 61 | 38 | 364 |
| 5 | 1.3 | | | 0.12 | Pd/Rh | 59 | 16.7 | 80 | 69 | 27 | 311 |

TABLE 5
Tetrametals based catalysts

| | Pd | Pt | Au | Rh | | H2O2 | H2O | Selectivity, % | | | Productivity |
|---|---|---|---|---|---|---|---|---|---|---|---|
| Ex. N° | % Wt | % Wt | % Wt | % Wt | | g/kg | g/kg | Init | Fin | Conversion, % | g H2O2/(g Pd × h) |
| 17 | 1.6 | 0.09 | 0.12 | 0.06 | Pd/Pt/Rh/Au | 84 | 31.9 | 69 | 60 | 53 | 360 |
| 18 | 1.3 | 0.09 | 0.08 | 0.06 | Pd/Pt/Rh/Au | 85.7 | 18.5 | 70 | 63 | 50 | 450 |
| 19 | 1.3 | 0.16 | 0.16 | 0.1 | Pd/Pt/Rh/Au | 73.7 | 28.2 | 67 | 60 | 50 | 383 |
| 4 | 1.3 | | | | Pd | 69.3 | 26.1 | 75 | 61 | 38 | 364 |
| 5 | 1.3 | | | 0.12 | Pd/Rh | 59 | 16.7 | 80 | 69 | 27 | 311 |
| 20 | 1.2 | 0.08 | 0.06 | 0.1 | Pd/Pt/Rh/Au | 58.3 | 31.1 | 68 | 52 | 37 | 330 |

TABLE 6
Influence of small amount of Rh on selectivity

| | Pd | Rh | | H2O2 | H2O | Selectivity, % | | | Productivity |
|---|---|---|---|---|---|---|---|---|---|
| Ex. N° | % Wt | % Wt | | g/kg | g/kg | Init | Fin | Conversion, % | g H2O2/(g Pd × h) |
| 21 | 1.2 | 0.9 | Pd/Rh | 25.5 | 58 | 71 | 23 | 50 | 65 |
| 22 | 1.59 | 1.88 | Pd/Rh | 17.3 | 60 | 48 | 14 | 52 | 33 |
| 23 | 1.4 | 0.76 | Pd/Rh | 17.9 | 73.8 | 31 | 11 | 63 | 39 |
| 24 | 1.5 | | Pd | 64.4 | 38.4 | 78 | 49 | 47 | 132 |
| 25 | 1.4 | 0.12 | Pd/Rh | 89.3 | 24.4 | 79 | 68 | 46 | 196 |
| 26 | 1.5 | 0.1 | Pd/Rh | 90.7 | 22.5 | 81 | 71 | 48 | 214 |

TABLE 7
Influence of small amount Rh in comparison to small amount of Pt or Au

| | Pd | Pt | Au | Rh | | H2O2 | H2O | Selectivity, % | | | Productivity |
|---|---|---|---|---|---|---|---|---|---|---|---|
| Ex. N° | % Wt | % Wt | % Wt | % Wt | | g/kg | g/kg | Init | Fin | Conversion, % | g H2O2/(g Pd × h) |
| 24 | 1.5 | | | | Pd | 64.4 | 38.4 | 78 | 49 | 47 | 132 |
| 27 | 1.5 | 0.15 | | | Pd/Pt | 89.3 | 37.9 | 65 | 56 | 57 | 183 |
| 25 | 1.4 | | | 0.12 | Pd/Rh | 89.3 | 24.4 | 79 | 68 | 46 | 196 |
| 28 | 1.25 | | 0.13 | | Pd/Au | 72.4 | 39.8 | 72 | 51 | 51 | 148 |
| 26 | 1.5 | | | 0.1 | Pd/Rh | 90.7 | 22.5 | 81 | 71 | 48 | 214 |

TABLE 8
Trimetals based catalysts compared to small amount of Rh only

| | Pd | Pt | Au | Rh | | H2O2 | H2O | Selectivity, % | | | Productivity |
|---|---|---|---|---|---|---|---|---|---|---|---|
| Ex. N° | % Wt | % Wt | % Wt | % Wt | | g/kg | g/kg | Init | Fin | Conversion, % | g H2O2/(g Pd × h) |
| 29 | 1.5 | 0.15 | | 0.11 | Pd/Pt/Rh | 90.9 | 34.5 | 68 | 59 | 69 | 185 |
| 24 | 1.5 | | | | Pd | 64.4 | 38.4 | 78 | 49 | 47 | 132 |
| 30 | 1.4 | 0.15 | 0.13 | | Pd/Pt/Au | 87.8 | 37.9 | 92 | 67 | 62 | 192 |
| 25 | 1.4 | | | 0.12 | Pd/Rh | 89.3 | 24.4 | 79 | 68 | 46 | 196 |
| 31 | 1.5 | 0.11 | 0.16 | | Pd/Pt/Au | 97.2 | 27.5 | 80 | 68 | 50 | 198 |
| 32 | 1.5 | | 0.1 | 0.1 | Pd/Au/Rh | 91.6 | 23.7 | 81 | 70 | 48 | 201 |
| 26 | 1.5 | | | 0.1 | Pd/Rh | 90.7 | 22.5 | 81 | 71 | 48 | 214 |

TABLE 9
Influence of small amount Rh in comparison to big amount of Pt or Au

| | Pd | Pt | Au | Rh | | H2O2 | H2O | Selectivity, % | | | Productivity |
|---|---|---|---|---|---|---|---|---|---|---|---|
| Ex. N° | % Wt | % Wt | % Wt | % Wt | | g/kg | g/kg | Init | Fin | Conversion, % | g H2O2/(g Pd × h) |
| 33 | 1.2 | 0.93 | | | | 59.2 | 50.5 | 60 | 39 | 59 | 151 |
| 34 | 1.4 | 1.6 | | | | 54.2 | 54.2 | 59 | 38 | 59 | 119 |
| 35 | 1.15 | 1.3 | | | | 61.7 | 61.7 | 49 | 35 | 68 | 165 |
| 36 | 1.2 | | 1.4 | | Pd/Au | 100.7 | 38.9 | 71 | 58 | 62 | 258 |
| 37 | 1.6 | | 1 | | Pd/Au | 101.6 | 39.2 | 78 | 60 | 62 | 196 |
| 38 | 1.3 | | 1.2 | | Pd/Au | 91.6 | 39.4 | 73 | 57 | 61 | 216 |
| 24 | 1.5 | | | | Pd | 64.4 | 38.4 | 78 | 49 | 47 | 132 |
| 25 | 1.4 | | | 0.12 | Pd/Rh | 89.3 | 24.4 | 79 | 68 | 46 | 196 |
| 26 | 1.5 | | | 0.1 | Pd/Rh | 90.7 | 22.5 | 81 | 71 | 48 | 214 |

TABLE 10
Tetrametals based catalysts

| | Pd | Pt | Au | Rh | | H2O2 | H2O | Selectivity, % | | | Productivity |
|---|---|---|---|---|---|---|---|---|---|---|---|
| Ex. N° | % Wt | % Wt | % Wt | % Wt | | g/kg | g/kg | Init | Fin | Conversion, % | g H2O2/(g Pd × h) |
| 39 | 1.1 | 0.07 | 0.05 | 0.06 | Pd/Pt/Rh/Au | 85.6 | 36.6 | 71 | 57 | 54 | 239 |
| 40 | 1.6 | 0.08 | 0.07 | 0.05 | Pd/Pt/Rh/Au | 96.3 | 33.4 | 71 | 62 | 57 | 184 |
| 41 | 1.5 | 0.15 | | 0.11 | Pd/Pt/Rh | 90.9 | 34.5 | 68 | 59 | 69 | 185 |
| 42 | 1.4 | 0.15 | 0.11 | 0.11 | Pd/Pt/Rh/Au | 91.9 | 35.4 | 73 | 58 | 58 | 202 |
| 24 | 1.5 | | | | Pd | 64.4 | 38.4 | 78 | 49 | 47 | 132 |
| 25 | 1.4 | | | 0.12 | Pd/Rh | 89.3 | 24.4 | 79 | 68 | 46 | 196 |
| 43 | 1.5 | 0.07 | 0.07 | 0.06 | Pd/Pt/Rh/Au | 76.5 | 39.9 | 66 | 52 | 53 | 156 |
| 26 | 1.5 | | | 0.1 | Pd/Rh | 90.7 | 22.5 | 81 | 71 | 48 | 214 |

TABLE 11
Repetability test

| | Pd | Rh | | H2O2 | H2O | Selectivity, % | | | Productivity |
|---|---|---|---|---|---|---|---|---|---|
| Ex. N° | % Wt | % Wt | | g/kg | g/kg | Init | Fin | Conversion, % | g H2O2/(g Pd × h) |
| 44 | 1.4 | 0.12 | Pd/Rh | 89.3 | 24.4 | 79 | 68 | 46 | 196 |
| 45 | 1.5 | 0.1 | Pd/Rh | 90.7 | 22.5 | 81 | 71 | 48 | 214 |

Trimetal Based Catalysts (Examples 8, 10, 29 and 32 According to the Invention and Examples 9, 30 and 31 Not According to the Invention):):

Pd/Au/Rh based catalysts show similar performances than Pd/Rh based catalysts (low Rh content). No interest exists then for such type of catalyst which would be more difficult to produce.

Pd/Pt/Rh based catalysts don't show very good performances. They show a selectivity equivalent to that of Pd/Pt based catalysts (with low Pt loading).

Pd/Pt/Au based catalysts show a similar to slightly lower selectivity than the one observed for the catalyst based on Pd/Rh (low Rh content). However, the catalyst preparation is more complex and more expensive too.

Tetrametals Based Catalysts (Examples 17-20 and 39-43, According to the Invention):

The Pd/Pt/Au/Rh based catalysts show a selectivity equivalent or slightly better than pure Pd based catalyst. Such type of catalysts would be difficult to prepare.

Should the disclosure of any patents, patent applications, and publications which are incorporated herein by reference conflict with the description of the present application to the extent that it may render a term unclear, the present description shall take precedence.

1. A catalyst comprising an amount of Pd supported on a carrier, said carrier comprising a silica core and a precipitate layer comprising a metal oxide, sulfate or phosphate on said core; said catalyst further comprising Rh supported on said carrier in an amount of from 1% to 50% of the amount of Pd.

2. The catalyst according to claim 1, wherein the metal oxide is selected from the group consisting of Zr oxides, Nb oxides, Ta oxides, Nb phosphate, and BaSO4.

3. The catalyst according to claim 1, wherein the metal oxide comprises ZrO₂ or BaSO₄.

4. The catalyst according to claim 3, wherein the metal oxide comprises BaSO₄.

5. The catalyst according to claim 1, wherein the amount of Pd supported on the carrier is from 0.001 to 10 wt. %.

6. The catalyst according to claim 1, wherein the amount of Rh supported to the carrier is from 2% to 30% of the amount of Pd.

7. The catalyst according to claim 6, wherein the amount of Rh supported on the carrier is from 5% to 20% of the amount of Pd.

8. The catalyst according to claim 1, wherein Rh and Pd are the only metals of Group 9 and Group 10 of the Periodic Table supported on its carrier.

9. A method for manufacturing the catalyst according to claim 1, comprising impregnating the carrier with Pd and Rh precursors.

10. The method according to claims 9, wherein the precursors comprise an inorganic or organic salt of Pd and an inorganic or organic salt of Rh.

11. The method according to claim 10, wherein the precursors comprise a halide salt of Pd and a halide salt of Rh.

12. The method according to claim 1, wherein Rh and Pd are the only metals of Group 9 and Group 10 of the Periodic Table supported on the carrier.

13. A method for making hydrogen peroxide by direct synthesis, comprising contacting a reaction medium comprising hydrogen and oxygen with a catalyst according to claim 1.

14. The method according to claim 13, wherein the reaction medium further comprises H⁺ and Br⁻ ions.

15. The method according to claim 10, wherein the precursors comprise a halide, acetate, nitrate, or oxalate salt of Pd and a halide, acetate, nitrate, or oxalate salt of Rh.

11. The method according to claim 11, wherein the precursors comprise a chloride or chloride hydrate salt of Pd and a chloride or chloride hydrate salt of Rh.
